(19) United States
(12) Patent Application Publication
(10) Pub. No.: US 2015/0078005 A1
(43) Pub. Date: Mar. 19, 2015

(54) SOLID-STATE LIGHTING DEVICES AND SYSTEMS

(71) Applicant: Express Imaging Systems, LLC, Seattle, WA (US)

(72) Inventors: John O. Renn, Lake Forest Park, WA (US); Bradley Burton Larsen, Seattle, WA (US); William G. Reed, Seattle, WA (US)

(21) Appl. No.: 14/488,069

(22) Filed: Sep. 16, 2014

Related U.S. Application Data
(60) Provisional application No. 61/878,425, filed on Sep. 16, 2013.

(51) Int. Cl. F21K 99/00; F21V 29/00; F21V 29/02; F21V 23/00; F21V 5/04

(52) U.S. Cl. CPC F21K 9/1355; F21V 23/005; F21V 5/046; F21V 5/04; F21V 29/027; F21V 29/22; F21V 23/007; F21Y 2103/022
USPC 362/294

(57) ABSTRACT

A solid-state lighting device for use in lieu of a gas discharge lamp, includes a housing; a lens coupled to the housing; a circuit board; and a plurality of solid-state light emitters carried by the circuit board and arranged to generate light to pass through the lens. An entirety of a form factor of the solid-state lighting device may be located within a cylindrical envelope having a length less than or about equal to an overall length of the gas discharge lamp and a diameter less than or about equal to the overall diameter of the gas discharge lamp. In addition, a light center length of the solid-state lighting device may be about equal to the light center length of the gas discharge lamp. Solid-state light emitters are arrayed with principal axes of emission radially spaced at least partially around and extending from a central axis of the lens.

### BACKGROUND

1. Technical Field

This disclosure generally relates to illumination, and more particularly to solid-state luminaires that are particularly well suited as replacements for conventional gas discharge lamps.

2. Description of the Related Art

With the increasing trend of energy conservation and for various other reasons, solid-state lighting has become more and more popular as the source of illumination in a wide range of applications. As is generally known, solid-state lighting refers to a type of lighting that emits light from a solid-state material, such as a block of semiconductor material. Such contrasts with more traditional forms of lighting, for example incandescent or fluorescent lighting which typically employ a filament in a vacuum tube or an electric discharge in a gas filled tube, respectively. Examples of solid-state light sources include light-emitting diodes (LEDs), organic light-emitting diodes (OLEDs), and polymer light-emitting diodes (PLEDs). Solid-state lighting devices typically require several solid-state light sources to produce a suitable level of illumination. In contrast, an example of a gas discharge lamp having a generally standard form is shown in FIG. 1. The gas discharge lamp is characterized by an overall length A, an overall diameter B and a light center length or burn center length C, as shown in FIG. 2.

Solid-state light sources tend to have increased lifespan compared to traditional lighting. This is because solid-state light sources have a greater resistance to shock, vibration, and wear. Solid-state light sources generate visible light with reduced parasitic energy dissipation (i.e., reduced heat generation) as compared to traditional lighting.

Applicant believes solid-state luminaires that have similar form factors and similar light output characteristics which are suitable to replace or replicate conventional gas discharge lamps are desirable.

### BRIEF SUMMARY

Solid-state lighting devices are provided with form factors and lighting characteristics well suited to replace or replicate existing gas discharge lamps. Embodiments of the solid-state lighting devices include solid-state luminaires that have approximately the same size and light output location (“burn center” of “light center length”) as conventional 75 W, 100 W, 150 W, 200 W, 250 W, 310 W, 410 W gas discharge lamps, such as, for example, a Metal Halide (MH) or a High Pressure Sodium (HPS) lamp.

Many existing luminaires have optical reflectors, lenses and other features that are designed to provide a consistent and predictable illumination pattern that enable lighting designers to reliably design lighting systems for commercial, industrial, municipal and other applications. Embodiments of the present invention provide solid-state luminaires that replace or replicate a gas discharge lamp (e.g., a MH or a HPS lamp) with a more energy efficient solution while substantially preserving the illumination pattern expected of the existing gas discharge lamp. Advantageously, the solid-state luminaires provide considerable energy savings and extended life relative to such gas discharge lamps. Additionally, unlike HPS or MH lamps, no igniter circuitry is required for the solid-state luminaires. The color quality may also be substantially improved over gas discharge lamps, as measured by the Color Rendering Index (CRI). Still further, the solid-state luminaires may generate much less heat than the replaced gas discharge lamps.

As an example, a solid-state lighting device for use in lieu of a gas discharge lamp having an overall length, an overall diameter and a light center length may be summarized as including a housing; a lens coupled to the housing; a circuit board positioned within an interior of the solid-state lighting device collectively defined by the housing and the lens; a plurality of solid-state light emitters carried by the circuit board and arranged to generate light to pass through the lens; and a heat sink physically coupled to the circuit board to dissipate heat generated by the solid-state light emitters, wherein an entirety of a form factor of the solid-state lighting device defined by the housing and the lens is located within a cylindrical envelope having a length less than or equal to a scale factor times the overall length of the gas discharge lamp and a diameter less than or equal to the scale factor times the overall diameter of the gas discharge lamp, the scale factor being between about 1.25 and about 1.0, and wherein a light center length of the solid-state lighting device is within a range of about 1.1 to about 0.9 times the light center length of the gas discharge lamp. The scale factor is 1.0 and the light center length of the solid-state lighting device may be within 0.25 inch of the light center length of the gas discharge lamp. The diameter of the cylindrical envelope within in which the form factor of the solid-state lighting device defined by the housing and annular lens may be located is 3.4 inches. The plurality of solid-state light emitters and lens may be arranged relative to each other to generate light with a distribution pattern substantially the same as the gas discharge lamp. The plurality of solid-state light emitters may be able to generate light with a visual appearance similar to the gas discharge lamp. The heat sink may include an annular outer surface and the circuit board may include a curvature that corresponds to the annular outer surface. The housing may include a base housing and a distal housing that may be distinct from the base housing, and wherein the lens may be positioned therebetween. The base housing may include a threaded base to physically and electrically couple the solid-state lighting device to a lighting fixture.

The solid-state lighting device may further include a fan received within the distal housing to move air through the solid-state lighting device during use. Each of the base housing and the distal housing may include a plurality of apertures to enable air moved by the fan to pass into the housing, across the heat sink and out of the housing. The solid-state light emitters may be electrically coupled by a series connection, and wherein the fan may be electrically coupled to a power tap located along the series connection.

The solid-state lighting device may further include a solid-state light emitter driver assembly positioned within the housing which extends from the base housing into the distal housing through an interior cavity of the lens. The lens may be annular and the plurality of solid-state light emitters may be arranged circumferentially about a central axis of the solid-state lighting device and radially inward of the lens.

In some instances, the solid-state light emitters may be arranged in a plurality of rows. The light center length of the solid-state lighting device may be defined by an average vertical position of the plurality of rows of the solid-state light emitters. For example, the solid-state light emitters may be arranged in two rows and the light center length of the solid-state lighting device may be located midway between the two rows. As another example, the solid-state light emitters may be arranged in three rows and the light center length of the solid-state lighting device may be aligned with a middle one of the rows. The solid-state light emitters of each row may be arranged in regular intervals and the solid-state light emitters of a first row may be circumferentially offset relative to corresponding solid-state light emitters of a second row. A distance between adjacent light emitters of each row may be about equal to or less than a distance between the rows.

The solid-state lighting device may further include an interconnect device to electrically couple the solid-state lighting device to a power source. The interconnect device may be one of a threaded lamp base, a wiring harness having a plurality of discrete wires, or a plurality of electrical connectors. The lens may include one or more materials to diffuse, refract and/or diffract light generated by the plurality of solid-state light emitters as the light passes through the lens.

The solid-state lighting device may further include an adapter removably coupleable to the housing to adjust the light center position of the solid-state lighting device. The adapter may be configured to adjust the light center position of the solid-state lighting device from a first location that is consistent with a first class of gas discharge lamps to a second location that is consistent with a second class of gas discharge lamps.

A solid-state lighting device may be summarized as including a housing having a base housing portion and a distal housing portion distinct from the base housing portion; an annular lens positioned between the base housing portion and the distal housing portion; a circuit board positioned within an interior of the solid-state lighting device; a plurality of solid-state light emitters carried by the circuit board and arranged circumferentially about a central axis of the solid-state lighting device in one or more rows to generate light to pass through the lens, the one or more rows of the solid-state light emitters defining a light center length; and a heat sink physically coupled to the circuit board to dissipate heat generated by the solid-state light emitters. The solid-state lighting device may replicate the light source of a gas discharge lamp having an overall gas discharge lamp length and an overall gas discharge lamp diameter, and an entirety of a form factor of the solid-state lighting device defined by the housing and the lens may be located within a cylindrical envelope having a length less than or equal to a scale factor times the overall gas discharge lamp length and a diameter less than or equal to the scale factor times the overall gas discharge lamp diameter, the scale factor being between about 1.25 and about 1.0 or between about 1.17 and about 1.0. The solid-state lighting device may replicate the light source of a gas discharge lamp having a light center length, and the light center length of the solid-state lighting device may be within a range of about 1.1 to about 0.9 times the light center length of the gas discharge lamp.

A solid-state lighting device for use in lieu of a gas discharge lamp having an overall length, an overall diameter and a light center length may be summarized as including a lens, the lens including a central axis; a plurality of solid-state light emitters, each of the solid-state light emitters having a respective principal axis of emission, at least three of the solid-state light emitters arrayed about the central axis of the lens with respective principal axes of radially extending outwardly through the lens; and wherein an entirety of a form factor of the solid-state lighting device is located within a cylindrical envelope having a length less than or equal to a scale factor times the overall length of the gas discharge lamp and a diameter less than or equal to the scale factor times the overall diameter of the gas discharge lamp, the scale factor being between about 1.25 and about 1.0, and wherein a light center length of the solid-state lighting device is within a range of about 1.1 to about 0.9 times the light center length of the gas discharge lamp. The scale factor may be 1.0 and the light center length of the solid-state lighting device may be within 0.25 inch of the light center length of the gas discharge lamp. The diameter of the cylindrical envelope within in which the form factor of the solid-state lighting device defined by the housing and annular lens may be located is 3.4 inches.

The solid-state lighting device may further include a housing to which the lens is physically coupled; a circuit board positioned within an interior of the solid-state lighting device collectively defined by the housing and the lens; and a heat sink physically coupled to the circuit board to dissipate heat generated by the solid-state light emitters.

### BRIEF DESCRIPTION OF THE SEVERAL VIEWS OF THE DRAWINGS

FIG. 1 is an elevational view of a conventional gas discharge lamp.

FIG. 2 is an elevational view of a conventional gas discharge lamp having a form factor with an overall length A, an overall diameter B and a light center length or burn center length C.

FIG. 3 is a skewed front view of a solid-state lighting device, according to one embodiment.

FIG. 4 is an exploded view of the solid-state lighting device of FIG. 3.

FIG. 5 is a cross-sectional view of the solid-state lighting device of FIG. 3.

FIGS. 6 and 7 are cross-sectional views of two example embodiments of solid-state lighting devices with different light center lengths.

FIG. 8 is an elevational view of an array of solid-state light emitters mounted to a flexible circuit board in a plurality of rows, according to one example embodiment.

FIG. 9 is an isometric view of an array of solid-state light emitters mounted to a pair of flexible circuit boards in a plurality of rows, according to another example embodiment.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with lighting fixtures, power supplies and/or power systems for lighting have not been shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense that is as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

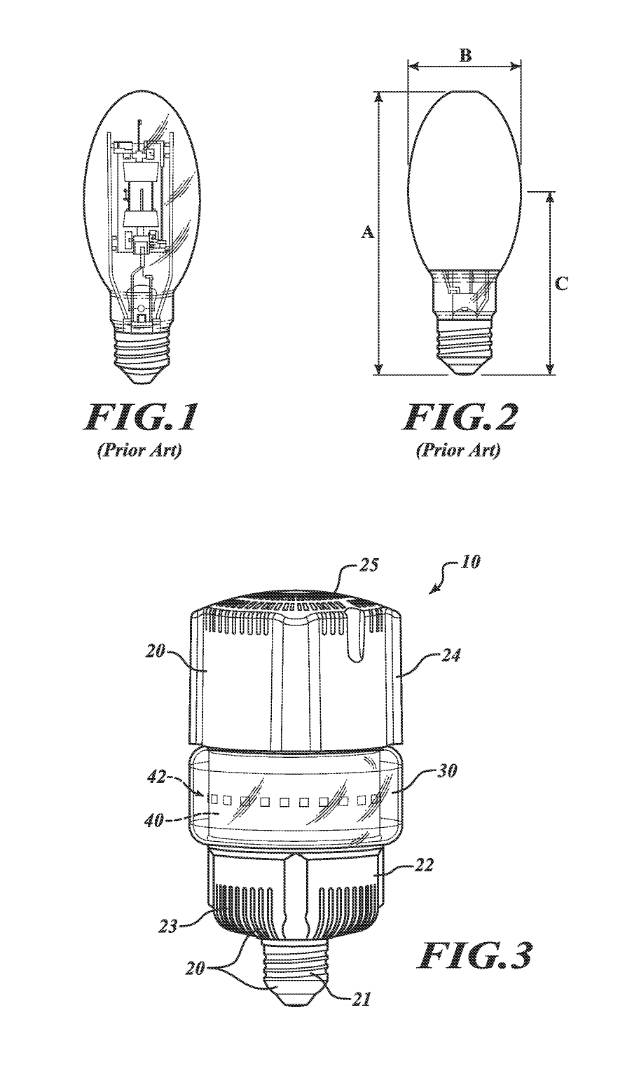

FIGS. 1 and 2 show a conventional gas discharge lamp having a form factor with an overall length A and an overall diameter B. The gas discharge lamp includes an outer protective envelope surrounding a smaller discharge tube which emits light at a consistent longitudinal distance from the lamp socket. The light emitting location is called the “burn center” or “light center length” C (FIG. 2) of the lamp. Many existing gas discharge luminaires have optical reflectors, lenses and other features that are designed to provide a consistent and predictable illumination pattern which enable lighting designers to reliably design lighting systems for commercial, industrial, municipal and other applications.

Embodiments of the solid-state lighting devices described herein are particularly well suited as replacements for such conventional gas discharge lamps. The solid-state lighting devices may have a form factor that is sized and shaped to fit within a cylindrical envelope similar to such conventional gas discharge lamps. The solid-state lighting devices may also have a same or similar light center length and may generate light with an intensity and/or a distribution that is substantially similar to that of conventional gas discharge lamps. Accordingly, embodiments of the solid-state lighting devices described herein may serve as drop-in replacements for conventional gas discharge lamps with little to no appreciable difference in lighting characteristics.

As an example, embodiments described herein provide solid-state luminaires having a plurality of solid-state light emitters (e.g., LEDs) arranged to produce light at a location substantially consistent with the burn center or light center length C (FIG. 2) of conventional gas discharge lamps. Optical reflectors, lenses and the physical configuration of the solid-state luminaires described herein may direct light in a manner that is nearly identical or very similar to the conventional gas discharge lamps that the luminaires replace, so that the luminaires provide a light distribution expected from the replaced lamps. Advantageously, little if any modification or redesign is needed when utilizing the solid-state luminaires to fulfill a lighting designer's original lighting design. In addition, lighting designers often use software to determine the number and location of luminaires for a particular installation. This software uses models of luminaires with known light distribution patterns and embodiments of the present invention enable the continued use of such software without modification.

FIGS. 3 through 5 show one example embodiment of a solid-state lighting device 10. The solid-state lighting device 10 includes a housing 20 having a base housing portion 22 and a distal housing portion 24 that is distinct from the base housing portion 22. A lens 30 is positioned between the base housing portion 22 and the distal housing portion 24. The base housing portion 22, the distal housing portion 24 and the intermediate lens 30 collectively define an outer contour or form factor of the solid-state lighting device 10. The lens 30 may be tubular or annular and include a central cavity within which other components of the lighting device 10 may be received. The lens 30 may comprise one or more materials to diffuse, refract and/or diffract light passing therethrough during operation of the lighting device 10.

The lens 30 may be placed around a plurality of solid-state light emitters 42 (e.g., LEDs) to protect them from moisture or other physical damage, and to diffuse light generated by the light emitters 42 so that the light has a pleasing appearance and is similar in appearance to light emanating from a gas discharge lamp. The lens 30 may comprise refractive or diffractive properties which may be used to produce a desired light pattern. In addition, the lens 30 may be coated with a dielectric reflective coating that selectively reflects some wavelengths of light while transmitting other wavelengths of light. There may be a reflective surface around the plurality of solid-state light emitters 42 that is coated with a wavelength converting phosphor that changes the color temperature of the emitted light in order to provide a more useful or pleasing appearance. The above elements are described in U.S. provisional patent application Ser. No. 61/295,519, filed Jan. 15, 2010; U.S. provisional patent application Ser. No. 61/406,490, filed Oct. 25, 2010; U.S. nonprovisional patent application Ser. No. 13/007,080, filed Jan. 14, 2011; U.S. provisional patent application Ser. No. 61/534,722, filed Sep. 14, 2011; and U.S. nonprovisional patent application Ser. No. 13/619,085, filed Sep. 14, 2012, which are incorporated herein by reference.

The base housing portion 22 and the distal housing portions 24 may be shell structures that include one or more internal cavities for receiving other components of the lighting device 10. The base housing portion 22 and the distal housing portions 24 may by cup-like structures. When assembled, the base housing portion 22, the distal housing portions 24 and the lens 30 may form a vessel to carry functional components of the lighting device 10. The housing 20 may further include a threaded base 21 to physically and electrically couple the solid-state lighting device 10 to a lighting fixture. In other instances, the threaded base 21 may physically couple the lighting device 10 to a lighting fixture and a separate or distinct interconnect device may be provided to electrically couple the solid-state lighting device 10 to a power source (e.g., AC mains power). The interconnect device may be, for example, a wiring harness having a plurality of discrete wires (i.e., a pig tail) or a plurality of electrical connectors, such as, for example, twist-lock pin connectors such as GU series connectors. The housing portions may be made from a white or other highly reflective material.

According to the illustrated embodiment of FIGS. 3 through 5, one or more circuit boards, for instance a circuit board 40, is or are positioned within an interior of the vessel collectively defined by the housing 20 and the lens 30. A plurality of solid-state light emitters 42 (e.g., LEDs) are carried by the circuit board 40 and arranged to generate light to pass through the lens 30 during operation. The solid-state light emitters 42 each have a respective principal axis of emission, which typically extends perpendicularly from an outer surface of the solid-state light emitters 42. The solid-state light emitters 42 are advantageously arrayed about a central or longitudinal axis, with their respective principal axes of emission extending radially outward from the central or longitudinal axis, for example in a 360 degree pattern. The solid-state light emitters 42 are advantageously arrayed about the central or longitudinal axis at a longitudinal distance therealong spaced from a base end such that a light center length LCL of the lighting device 10 at least approximately matches that of a type of lighting device which the lighting device 10 is designed to replace or replicate.

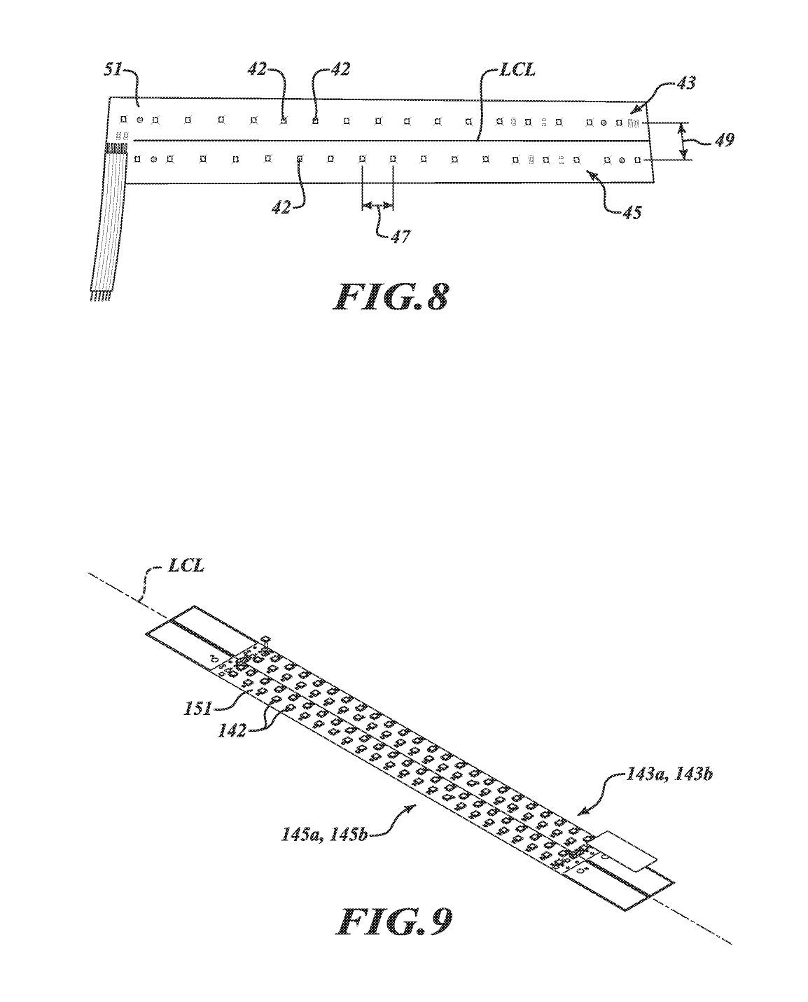

With reference to FIG. 8, in some embodiments the solid-state light emitters 42 may be arranged in a plurality of rows 43, 45. In such embodiments, the light center length LCL of the solid-state lighting device 10 may be defined by an average vertical position of the plurality of rows 43, 45 of the solid-state light emitters 42. For example, the solid-state light emitters 42 may be arranged in two rows 43, 45, as shown in FIG. 8, and the light center length LCL of the solid-state lighting device 10 may be located midway between the two rows 43, 45. As another example, the solid-state light emitters 42 may be arranged in three rows and the light center length LCL of the solid-state lighting device 10 may be aligned with a middle one of the rows. The solid-state light emitters 42 of each row 43, 45 may be arranged in regular intervals and the solid-state light emitters 42 of a first row 43 may be circumferentially offset relative to corresponding solid-state light emitters 42 of a second row 45. In some embodiments, a distance 47 between adjacent light emitters 42 of each row 43, 45 may be about equal to or less than a distance 49 between the rows 43, 45. In some embodiments, the solid-state light emitters 42 may be located in a pattern where each solid-state light emitter 42 is about or substantially equidistant from adjacent solid-state light emitter emitters 42 and from the light center length LCL which is defined between adjacent rows 43, 45 of the solid-state light emitter emitters 42.

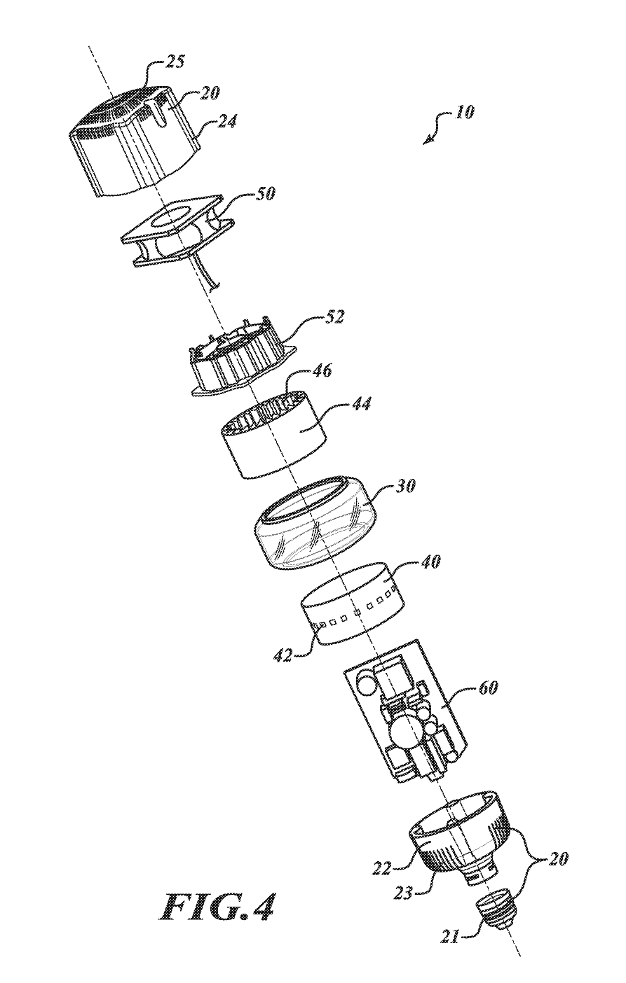

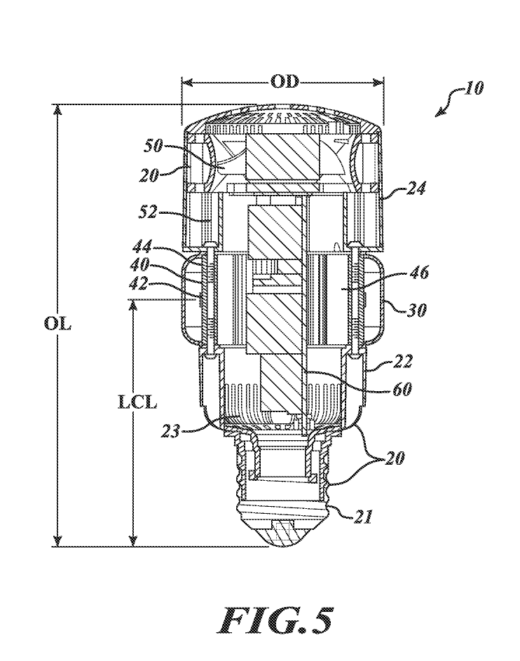

The solid-state light emitters 42 may be mounted on a flexible or bendable printed circuit board 51 or on individual rigid printed circuit boards and attached or secured to a heat sink 44 (FIGS. 4 and 5) to dissipate heat generated by the solid-state light emitters 42. In one implementation, a single flexible or bendable printed circuit board may be disposed completely or nearly completely about a central or longitudinal axis, to form an annulus. In another implementation, a plurality of rigid printed circuit boards may be disposed completely or nearly completely about a central or longitudinal axis, each constituting a respective facet of a polygonal annular shape about the central or longitudinal axis. In yet another implementation, a plurality of flexible or bendable printed circuit boards may be disposed completely or nearly completely about a central or longitudinal axis, each constituting a respective facet of a polygonal annular shape. Use of flexible or bendable printed circuit boards may reduce the total number of facets on the polygonal annular shape. A thermal interface material, such as thermally conductive grease, self-adhesive thermally conductive tape, or other such material may be placed between the heat sink and the printed circuit board to increase heat conduction from the circuit board to the heat sink. The printed circuit board may be adhered to the heat sink by means of a double sided thermally conductive adhesive tape.

FIG. 9 shows another example embodiment in which a plurality of solid-state light emitters 142 are arranged in a plurality of rows 143a, 143b, 145a, 145b on flexible or bendable printed circuit boards 151. In such an embodiment, the light center length LCL of a host solid-state lighting device including the solid-state light emitters 142 may be defined by an average vertical position of the plurality of 143a, 143b, 145a, 145b of the solid-state light emitters 142. More particularly, the solid-state light emitters 142 may be arranged in the four rows 143a, 143b, 145a, 145b shown in FIG. 9, and the light center length LCL may be located midway between the two opposing sets of rows 143a, 143b and 145a, 145b. In other embodiments, the solid-state light emitters 142 may be arranged in various other linear arrays, or in non-linear arrangements. In some instances, greater quantities of low or mid power solid-state light emitters 142 (e.g., LEDs) may be used in place of high power (e.g., >1 watt) solid-state light emitters to make the collective light source more diffused and/or lower the manufacturing cost of the device. As an example, in some embodiments, including the example shown in FIG. 9, an array of solid-state light emitters 142 may be provided on one or more flexible or bendable printed circuit boards 151 having up to or more than 96 individual solid-state light emitters 142. The one or more circuit boards 151 may be attached or secured to a heat sink, such as the heat sink 44 shown in FIGS. 4 and 5, to dissipate heat generated by the solid-state light emitters 142.

With reference again to FIGS. 3 through 5, the heat sink 44 may include a plurality of fins, projections, surface treatment, or other features 46 that increase the effective surface area of the heat sink 44 to enhance its cooling capabilities. In some embodiments, the fins, projections or other features 46 may extend from a generally tubular body inwardly toward a central axis of the solid-state lighting device 10. In some embodiments the heat sink may be coated with a nano-particle surface treatment to increase thermal radiation from its surface.

The heat sink 44 may include an annular outer surface and the circuit board 40 may include a curvature that corresponds to the annular outer surface, whether faceted or whether having a constant radius of curvature. The circuit board 40 may be attached directly or indirectly to the annular outer surface of the heat sink 44. According to one embodiment, a flexible printed circuit board may be wrapped around the heat sink 44 to mount the plurality of solid-state light emitters 42. Other embodiments may use discrete PCBs wired together which are mounted to the outer circumference of the heat sink 44, or a bendable metal core PCB which is bent or folded to conform to the outer circumference of the heat sink 44. For example, the circuit board 40 may include those described in U.S. Patent Publication No. US 2011/0310605, published Dec. 22, 2011, which is incorporated herein by reference in its entirety. The plurality of solid-state light emitters 42 may be placed or located such that they are at a burn center distance or light center length LCL (FIG. 5) from a base end of the lighting device 10.

According to some embodiments, the lens 30 may be molded from flexible silicone or other translucent or transparent resin such that the inside diameters of opposing ends of the lens 30 are smaller than an outside diameter of the heat sink 44. During assembly, the lens 30 may be held in an expanded state while the lens 30 is placed over internal components of the lighting device 10, and then allowed to relax or constrict around the heat sink 44, thereby forming a tight seal against water ingress or other contaminants. The resin may have diffusing particles or wavelength converting phosphors embedded in, or coated onto the resin.

A solid-state light emitter driver assembly 60 may be positioned within the housing 20 to extend from the base housing 22 into the distal housing 24 through an interior cavity of the lens 30 and an interior cavity of the heat sink 44. The driver assembly 60 may be of the LLC Resonant Converter type, Flyback Converter type, Buck Converter type, PFC Boost Converter type, AC Direct Drive type or other power converter.

A communications interface to the solid-state light emitter driver assembly 60 may be included to permit wireless communication, wired communication or other methods for controlling the brightness and/or other characteristics of the light emitters 42. For example, a “0 to 10V” dimming control may be incorporated. As another example, a Bluetooth Smart wireless control may be provided. A photo control to switch the lamp on or off depending upon the natural ambient light may also be incorporated. A ZigBee™ wireless interface may be used for communication between individual lighting devices 10, or between a base station (not shown) and the lighting devices 10, to control the brightness and/or other characteristics of the light emitters 42 thereof. In some embodiments, the driver assembly 60 may be coated with Acrylic, Silicone or Parylene to protect it from moisture and dust, and to electrically insulate it for safety and safety compliance purposes.

A fan 50 or other type of air mover (e.g., synthetic jet) may be provided within the housing 20 to move air across the heat sink 44 during operation to assist in dissipating heat generated by the solid-state light emitters 42. In addition, the fan 50 may assist in dissipating heat generated by the solid-state light emitter driver assembly or module 60. In some embodiments, the fan 50 may be positioned within the distal housing portion 24 and coupled directly or indirectly to the heat sink 44. For example, according to the example embodiment of FIGS. 3 through 5, the fan 50 is positioned within the housing 20 and offset from the heat sink 44 by an adapter or spacer 52. The adapter or spacer 52 includes a generally annular sidewall to space the fan away from the heat sink 44 within the distal housing 24 and at least one central aperture extending therethrough so heated air may be moved through the adapter or spacer 52 and the heat sink 44 by the fan 50. The adapter or spacer 52 may include or define a central cavity within which functional components of the lighting device 10 may be received.

Each of the base housing 22 and the distal housing 24 may include a plurality of apertures 23, 25 (e.g., slots, louvers, etc.) to enable air moved by the fan 50 to pass into the housing 20, across the heat sink 44 and out of the housing 20, while the housing 20 nevertheless provides protection from electrical shock and physical damage. The fan 50 may draw or push air through the heat sink 44 in a direction from the base housing 22 toward the distal housing 24 or from the distal housing 24 toward the base housing 22. In some embodiments in which the solid-state light emitters 42 are electrically coupled by a series connection, the fan 50 may be electrically coupled to a power tap or taps located along the series connection. For example, in one embodiment, the power to run the fan 50 may be taken from a tap on an LED series string. In the case of a 12V fan, the tap may be placed on the anode of a fourth LED from the negative end of the string. The positive fan lead may be connected to the tap and the negative fan lead may be connected to an isolated secondary ground or the cathode of the first LED in the series string. The tap may also be, in this example, the fourth LED from the positive end of the LED string, with the positive fan wire connected to the anode of the most positive end of the LED string and the negative fan lead connected to the cathode of the fourth LED from the positive end of the LED string. Alternately, two taps could be used, with the fan wires placed across any four consecutive LEDs in the series string. More or fewer LEDs in the string may be used for different fan voltages. In other embodiments, the fan 50 may be electrically coupled to receive power from the driver assembly 60 retained within the housing 20.

With reference to FIG. 5, an entirety of a form factor of the solid-state lighting device 10 defined by the housing 20 and the lens 30 may be located within a cylindrical envelope having an overall length OL less than or equal to a scale factor times the overall length A (FIG. 2) of a gas discharge lamp that the lighting device 10 is intended to replace or replicate, and an overall diameter OD less than or equal to the scale factor times the overall diameter B (FIG. 2) of the gas discharge lamp. In some embodiments, the scale factor may be between about 1.1 and about 1.0 such that the lighting device 10 falls within a cylindrical reference envelope having major dimensions no more than 10% greater than corresponding dimensions of the gas discharge lamp that the lighting device 10 replaces or replicates. In some embodiments, the scale factor may be 1.0 such that the lighting device 10 falls within a cylindrical reference envelope having major dimensions no greater than corresponding dimensions of the gas discharge lamp that the lighting device 10 replaces or replicates.

With continued reference to FIG. 5, a light center length LCL of the solid-state lighting device 10 may fall within a range of about 1.1 to about 0.9 times the light center length C (FIG. 2) of the gas discharge lamp that the lighting device 10 is designed to replace or replicate. In some embodiments, the light center length LCL of the solid-state lighting device 10 may be within 0.25 inch of the light center length C of the gas discharge lamp that the lighting device 10 is designed to replace or replicate, and in other embodiments may be within 0.10 inch of the light center length C of the gas discharge lamp. The light center length LCL of the lighting device 10 may correspond to a distance between a base end of the lighting device 10 and a reference plane defined by a circumferential arrangement of the solid-state light emitters 42 positioned radially inward of the lens 30.

In some embodiments, an adapter (not shown) may be provided, which is removably coupleable to the housing 20 to selectively adjust the light center length LCL of the solid-state lighting device 10. For example, in some embodiments, an adapter may be configured to adjust the light center length LCL of the solid-state lighting device 10 from a first location that is consistent with a first class of gas discharge lamps to a second location that is consistent with a second class of gas discharge lamps. According to one embodiment, the housing 20 may be provided with a standard Medium Base screw-in lamp base. A larger “Mogul” base (E39 or E40) adapter may be attached or screwed-on over the Medium Base. The Medium Base may position the burn center or light center to be similar to the burn center or light center on smaller 70 watt or other small envelope MH or HPS lamps. The dimensions of the larger Mogul base adapter may be such that adding the Mogul adapter moves the burn center or light center to a location similar to the burn center or light center of larger envelope MH or HPS lamps.

According to some embodiments, a pigtail exiting the end of the housing 20 may be used in lieu of a screw-in type electrical interconnect device. For example, a non-conductive screw-in adapter may be used which allows the embodiment to be mechanically mounted in an existing socket, but with the pigtail used to electrically connect the embodiment at a different location. Alternatively, a mounting bracket may be attached to embodiments of the lighting devices 10 described herein to mechanically mount the lighting devices 10 in a host fixture or luminaire. According to other embodiments, a clamp adapter may be provided which is configured to clamp the lighting device 10 to the external surface of a light socket using a screw, a spring or other fastener to tighten the clamp adapter around the light socket thereby mechanically mounting the lighting device in a desired location without modifying the luminaire.

According to some embodiments, the light emitters 42 (e.g., LEDs) may be circumferentially spaced about a central or longitudinal axis of the lighting device 10 in a regular or irregular manner and may be connected in series or otherwise to illuminate simultaneously and generate a halo of emitted light through the lens 30 with a burn center or light center length LCL aligned with a reference plane defined by the plurality of light emitters 42. The light emitters 42 may be positioned at are in close proximity to a mid-plane of the lens 30. Again, the lens 30 may be shaped, configured or otherwise constructed to assist in replicating a light distribution that mimics or is substantially the same (i.e., nearly indistinguishable to a user of average vision) as that of a gas discharge lamp that the lighting device 10 is intended to replace or replicate. The plurality of solid-state light emitters 42 may be able to generate light with intensity equal to or greater than the gas discharge lamp that the lighting device 10 is intended to replace.

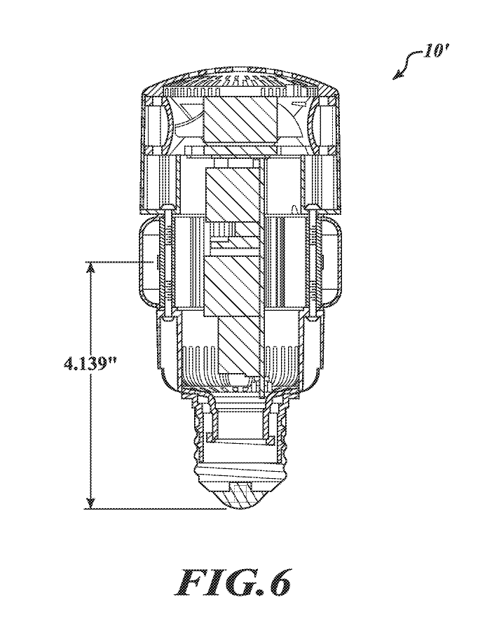

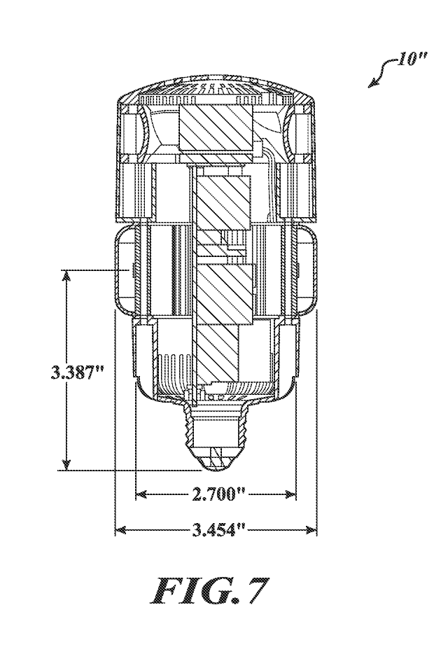

FIGS. 6 and 7 show embodiments of solid-state lighting devices 10′, 10″ having a similar construction to the lighting devices 10 described above and having different specific light center length LCL configurations. In particular, FIG. 6 shows an embodiment of a solid-state lighting device 10′ having a light center length LCL of 4.139″, which is well suited to replace or replicate a conventional gas discharge lamp having the same or a similar light center length, and FIG. 7 shows an embodiment of a solid-state lighting device 10″ having a light center length LCL of 3.387″, which is well suited to replace or replicate a gas discharge lamp having the same or a similar light center length. A housing of the embodiment of FIG. 6 includes a relatively larger threaded base for physically and electrically coupling the device 10′ to a conventional light fixture having a correspondingly sized socket, and FIG. 7 includes a relatively smaller threaded base for physically and electrically coupling the device 10″ to a conventional light fixture having a correspondingly sized socket.

With reference to FIG. 7, and according to some embodiments, the overall diameter of the cylindrical envelope within which the form factor of the solid-state lighting device 10″ may be located may be about 3.5 inches or less. For example, an overall outer diameter or dimension of the lighting device 10″ shown in FIG. 7 is about 3.454″. Advantageously, this allows the solid-state lighting device 10″ to be installed in luminaires that have provided clearance for standard gas discharge lamps of a corresponding size. In other embodiments, the outer diameter or dimension of the lighting device may be more or less than 3.5 inches.

Although the embodiments of the lighting devices 10, 10′, 10″ shown in FIGS. 3 through 7 include an external profile defined collectively by opposing housing portions 22, 24 and an intermediate lens 30, it is appreciated that in other embodiments more or fewer components may be combined to collectively define the external profile of the lighting devices 10, 10′, 10″.

Moreover, the various embodiments described above can be combined to provide further embodiments. To the extent that they are not inconsistent with the specific teachings and definitions herein, all of the U.S. patents, U.S. patent application publications, U.S. patent applications, foreign patents, foreign patent applications and non-patent publications referred to in this specification and/or listed in the Application Data Sheet, including but not limited to U.S. Provisional Patent Application No. 61/052,924, filed May 13, 2008; U.S. Patent Publication No. US2009/0284155, published Nov. 19, 2009; U.S. Provisional Patent Application No. 61/051,619, filed May 8, 2008; U.S. Pat. No. 8,118,456, issued Feb. 12, 2012; U.S. Provisional Patent Application No. 61/088,651, filed Aug. 13, 2008; U.S. Pat. No. 8,334,640, issued Dec. 18, 2012; U.S. Provisional Patent Application No. 61/115,438, filed Nov. 17, 2008; U.S. Provisional Patent Application No. 61/154,619, filed Feb. 23, 2009; U.S. Patent Publication No. US2010/0123403, published May 20, 2010; U.S. Provisional Patent Application No. 61/174,913, filed May 1, 2009; U.S. Patent Publication No. US2010/0277082, published Nov. 4, 2010; U.S. Provisional Patent Application No. 61/180,017, filed May 20, 2009; U.S. Patent Publication No. US2010/0295946, published Nov. 25, 2010; U.S. Provisional Patent Application No. 61/229,435, filed Jul. 29, 2009; U.S. Patent Publication No. US2011/0026264, published Feb. 3, 2011; U.S. Provisional Patent Application No. 61/295,519 filed Jan. 15, 2010; U.S. Provisional Patent Application No. 61/406,490 filed Oct. 25, 2010; U.S. Pat. No. 8,378,563, issued Feb. 19, 2013; U.S. Provisional Patent Application Ser. No. 61/333,983, filed May 12, 2010; U.S. Pat. No. 8,541,950, issued Sep. 24, 2013; U.S. Provisional Patent Application Ser. No. 61/346,263, filed May 19, 2010, U.S. Pat. No. 8,508,137, issued Aug. 13, 2013; U.S. Provisional Patent Application Ser. No. 61/357,421, filed Jun. 22, 2010; U.S. Patent Publication No. US2011/0310605, published Dec. 22, 2011; U.S. Patent Publication No. 2012/0262069, published Oct. 18, 2012; U.S. Pat. No. 8,610,358, issued Dec. 17, 2013; U.S. Provisional Patent Application Ser. No. 61/527,029, filed Aug. 24, 2011; U.S. Pat. No. 8,629,621, issued Jan. 14, 2014; U.S. Provisional Patent Application Ser. No. 61/534,722, filed Sep. 14, 2011; U.S. Patent Publication No. 2013/0062637, published Mar. 14, 2013, filed Sep. 14, 2012; U.S. Provisional Patent Application Ser. No. 61/567,308, filed Dec. 6, 2011; U.S. Provisional Patent Application Ser. No. 61/561,616, filed Nov. 18, 2011; U.S. Provisional Patent Application Ser. No. 61/641,781, filed May 2, 2012; U.S. Patent Publication No. 2013/0229518, published Sep. 5, 2013; U.S. Provisional Patent Application Ser. No. 61/640,963, filed May 1, 2012; U.S. Provisional Patent Application No. 61/764,395 filed Feb. 13, 2013; U.S. Patent Publication No. 2013/0028198, published Jan. 30, 2014; U.S. Provisional Patent Application Ser. No. 61/692,619, filed Aug. 23, 2012; U.S. Provisional Patent Application Ser. No. 61/694,159, filed Aug. 28, 2012; U.S. Patent Publication No. 2014/0062341, published Mar. 6, 2014; U.S. Provisional Patent Application Ser. No. 61/723,675, filed Nov. 7, 2012; U.S. Patent Publication No. 2013/0141010, published Jun. 6, 2013; U.S. Provisional Patent Application Ser. No. 61/728,150, filed Nov. 19, 2012; U.S. Provisional Patent Application Ser. No. 61/764,395, filed Feb. 13, 2013; U.S. Patent Publication No. 2014/0062312, published Mar. 6, 2014, U.S. Patent Publication No. 2014/0139116, published May 22, 2014; U.S. Non-Provisional Patent Application No. 13/875,000 filed May 1, 2013; U.S. Provisional Patent Application No. 61/849,841 filed Jul. 24, 2013; U.S. Provisional Patent Application No. 13/973,696 filed Aug. 22, 2013; U.S. Provisional Patent Application No. 61/878,425 filed Sep. 16, 2013, are incorporated herein by reference, in their entirety. Aspects of the embodiments can be modified, if necessary, to employ systems, circuits and concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A solid-state lighting device for use in lieu of a gas discharge lamp having an overall length, an overall diameter and a light center length, the solid-state lighting device comprising:
a housing;
a lens coupled to the housing;
a circuit board positioned within an interior of the solid-state lighting device collectively defined by the housing and the lens;
a plurality of solid-state light emitters carried by the circuit board and arranged to generate light to pass through the lens; and
a heat sink physically coupled to the circuit board to dissipate heat generated by the solid-state light emitters,
wherein an entirety of a form factor of the solid-state lighting device defined by the housing and the lens is located within a cylindrical envelope having a length less than or equal to a scale factor times the overall length of the gas discharge lamp and a diameter less than or equal to the scale factor times the overall diameter of the gas discharge lamp, the scale factor being between about 1.25 and about 1.0, and
wherein a light center length of the solid-state lighting device is within a range of about 1.1 to about 0.9 times the light center length of the gas discharge lamp.

2. The solid-state lighting device of claim 1 wherein the scale factor is 1.17 and the light center length of the solid-state lighting device is within 0.25 inch of the light center length of the gas discharge lamp.

3. The solid-state lighting device of claim 1 wherein the diameter of the cylindrical envelope within in which the form factor of the solid-state lighting device defined by the housing and annular lens is located is 3.4 inches.

4. The solid-state lighting device of claim 1 wherein the plurality of solid-state light emitters and lens are arranged relative to each other to generate light with a distribution pattern substantially the same as the gas discharge lamp.

5. The solid-state lighting device of claim 1 wherein the plurality of solid-state light emitters are able to generate light with an intensity equal to or greater than the gas discharge lamp.

6. The solid-state lighting device of claim 1 wherein the heat sink includes an annular outer surface and the circuit board includes a curvature that corresponds to the annular outer surface.

7. The solid-state lighting device of claim 1 wherein the housing includes a base housing and a distal housing that is distinct from the base housing, and wherein the lens is positioned therebetween.

8. The solid-state lighting device of claim 7 wherein the base housing includes a threaded base to physically and electrically couple the solid-state lighting device to a lighting fixture.

9. The solid-state lighting device of claim 7, further comprising:
a fan received within the distal housing to move air through the solid-state lighting device during use.

10. The solid-state lighting device of claim 9 wherein each of the base housing and the distal housing include a plurality of apertures to enable air moved by the fan to pass into the housing, across the heat sink and out of the housing.

11. The solid-state lighting device of claim 9 wherein the solid-state light emitters are electrically coupled by a series connection, and wherein the fan is electrically coupled to a power tap located along the series connection.

12. The solid-state lighting device of claim 7, further comprising:
a solid-state light emitter driver assembly positioned within the housing which extends from the base housing into the distal housing through an interior cavity of the lens.

13. The solid-state lighting device of claim 1 wherein the lens is annular and the plurality of solid-state light emitters are arranged circumferentially about a central axis of the solid-state lighting device and radially inward of the lens.

14. The solid-state lighting device of claim 13 wherein the solid-state light emitters are arranged in a plurality of rows.

15. The solid-state lighting device of claim 14 wherein the light center length of the solid-state lighting device is defined by an average position of the plurality of rows of the solid-state light emitters.

16. The solid-state lighting device of claim 14 wherein the solid-state light emitters are arranged in two rows and the light center length of the solid-state lighting device is located midway between the two rows.

17. The solid-state lighting device of claim 14 wherein the solid-state light emitters are arranged in three rows and the light center length of the solid-state lighting device is aligned with a middle one of the rows.

18. The solid-state lighting device of claim 14 wherein the solid-state light emitters of each row are arranged in regular intervals and wherein the solid-state light emitters of a first row are circumferentially offset relative to corresponding solid-state light emitters of a second row.

19. The solid-state lighting device of claim 14 wherein a distance between adjacent light emitters of each row is about equal to or less than a distance between the rows.

20. The solid-state lighting device of claim 1, further comprising an interconnect device to electrically couple the solid-state lighting device to a power source.

21. The solid-state lighting device of claim 20 wherein the interconnect device is one of a threaded lamp base, a wiring harness having a plurality of discrete wires, or a plurality of electrical connectors.

22. The solid-state lighting device of claim 1 wherein the lens comprises one or more materials to diffuse, refract and/or diffract light generated by the plurality of solid-state light emitters as the light passes through the lens.

23. The solid-state lighting device of claim 1, further comprising:
an adapter removably coupleable to the housing to adjust the light center position of the solid-state lighting device.

24. The solid-state lighting device of claim 23 wherein the adapter is configured to adjust the light center position of the solid-state lighting device from a first location that is consistent with a first class of gas discharge lamps to a second location that is consistent with a second class of gas discharge lamps.

25. A solid-state lighting device, comprising:
a housing having a base housing portion and a distal housing portion distinct from the base housing portion;
an annular lens positioned between the base housing portion and the distal housing portion;
a circuit board positioned within an interior of the solid-state lighting device;
a plurality of solid-state light emitters carried by the circuit board and arranged circumferentially about a central axis of the solid-state lighting device in one or more rows to generate light to pass through the lens, the one or more rows of solid-state light emitters defining a light center length; and
a heat sink physically coupled to the circuit board to dissipate heat generated by the solid-state light emitters.

26. The solid-state lighting device of claim 25 wherein the solid-state lighting device replicates the light source of a gas discharge lamp having an overall gas discharge lamp length and an overall gas discharge lamp diameter, and wherein an entirety of a form factor of the solid-state lighting device defined by the housing and the lens is located within a cylindrical envelope having a length less than or equal to a scale factor times the overall gas discharge lamp length and a diameter less than or equal to the scale factor times the overall gas discharge lamp diameter, the scale factor being between about 1.25 and about 1.0.

27. The solid-state lighting device of claim 19 wherein the solid-state lighting device replicates the light source of a gas discharge lamp having a light center length, and wherein the light center length of the solid-state lighting device is within a range of about 1.1 to about 0.9 times the light center length of the gas discharge lamp.

28. A solid-state lighting device for use in lieu of a gas discharge lamp having an overall length, an overall diameter and a light center length, the solid-state lighting device comprising:
a lens, the lens including a central axis;
a plurality of solid-state light emitters, each of the solid-state light emitters having a respective principal axis of emission, at least three of the solid-state light emitters arrayed about the central axis of the lens with respective principal axes of the solid-state light emitters radially extending outwardly through the lens; and
wherein an entirety of a form factor of the solid-state lighting device is located within a cylindrical envelope having a length less than or equal to a scale factor times the overall length of the gas discharge lamp and a diameter less than or equal to the scale factor times the overall diameter of the gas discharge lamp, the scale factor being between about 1.25 and about 1.0, and
wherein a light center length of the solid-state lighting device is within a range of about 1.1 to about 0.9 times the light center length of the gas discharge lamp.

29. The solid-state lighting device of claim 28 wherein the scale factor is 1.7 and the light center length of the solid-state lighting device is within 0.25 inch of the light center length of the gas discharge lamp.

30. The solid-state lighting device of claim 28 wherein the diameter of the cylindrical envelope within in which the form factor of the solid-state lighting device defined by the housing and annular lens is located is 3.4 inches.

31. The solid-state lighting device of claim 28, further comprising:
a housing to which the lens is physically coupled;
a circuit board positioned within an interior of the solid-state lighting device collectively defined by the housing and the lens; and
a heat sink physically coupled to the circuit board to dissipate heat generated by the solid-state light emitters.

32. The solid-state lighting device of claim 28 wherein the solid-state light emitters are arranged in a plurality of rows.
